(19) United States
(12) Patent Application Publication
(10) Pub. No.: US 2010/0011511 A1
(43) Pub. Date: Jan. 21, 2010

(54) Enzyme Foam Treatment For Laundry

(75) Inventors: Lilian Eva Tang Baltsen, Bagsvaerd (DK); Jesper Duus Nielsen, Copenhagen (DK)

Correspondence Address: NOVOZYMES NORTH AMERICA, INC., 500 FIFTH AVENUE, SUITE 1600, NEW YORK, NY, 10110, US

(73) Assignee: Novozymes A/S, Bagsvaerd (DK)

(21) Appl. No.: 12/526,789

(22) PCT Filed: Feb. 20, 2008
(86) PCT No.: PCT/EP08/52071

§ 371 Date: Aug. 12, 2009

(30) Foreign Application Priority Data
Feb. 20, 2007 (EP) 07102729.6

(51) Int. Cl. C11D 3/386; C11D 17/00

(52) U.S. Cl. 8/137; 510/284

(57) ABSTRACT

A new method for laundering fabrics is disclosed, where a foam composition comprising enzymes and a surfactant is distributed over fabrics. After a holding period water and a detergent composition is added and the fabrics are washed under usual washing conditions. After the washing period suds are discharged and the fabrics are rinsed and dried using usual means.

### FIELD OF INVENTION

The invention related to methods for laundry of fabrics and enzyme compositions for use in said method. In particular the invention relates to foam compositions comprising one or more enzymes.

### BACKGROUND FOR THE INVENTION

Generally laundry is performed by agitating the fabrics in a detergent solution for a certain period of time followed by rinsing the fabrics in water. Laundry may be performed in an automatised washing machine or it may be performed as a handwash. Modern detergents are complex compositions comprising a number of components such as surfactants, builders, bleach, polymers and enzymes, usually formulated as a powder or a liquid.

Several modifications of the laundry process and the detergent compositions have been suggested in order to increase the performance of the laundry process or in order to reduce the water or energy consumption of the laundry.

WO 9820100A1 discloses detergent compositions comprising enzymes in form of a foam, a device for dispensing such a composition e.g. an aerosol can, and a process for washing laundry using the foam. The process comprises dispensing the foam on the laundry or in water to prepare suds, optionally a holding period and finally agitating, rinsing conditioning etc.

U.S. Pat. No. 6,303,563 discloses detergent compositions comprising enzymes in form of a foam further comprising a diester or diamide quaternary ammonium compound and optionally a boron enzyme stabilizer. Further a process for washing laundry is disclosed comprising dispensing the foam on the laundry or in water to prepare suds, optionally a holding period and finally agitating, rinsing conditioning etc.

EP 86935 discloses a method of washing soiled textile goods where foam is created and blown on the textile. The benefit of the method is that it can be performed using small amounts of detergent and water. The document does not mention enzymes.

U.S. Pat. No. 5,435,809 discloses a method of treating denim textiles in order to obtain a “stonewashed” appearance where the textile is treated with a foam comprising cellulases.

EP 677 577 discloses detergent composition in form of a foam. In the examples enzyme are included in the foam. In use the compositions are distributed on prewetted textiles and optionally soaked for a time period, followed by addition of water and agitating the mixture.

GB 2,417,492 discloses a detergent dispenser for delivering detergent in e.g. a dishwasher. The document discusses the possibility of including different detergent compositions in different chambers in the cartridge in order to deliver different compositions in different stages of the washing programme.

### SUMMARY OF THE INVENTION

In one aspect the present invention relates to a method for laundering fabrics comprising the steps of:
a) Distributing a foam composition comprising enzymes over fabrics followed by a holding period, and
b) Adding water and preferably a detergent composition and agitating the mixture.
   Each of these steps can be repeated.

In a second aspect the invention relates to a foam composition comprising one or more foaming agents and one or more enzymes. The enzymes are preferably selected among a protease, lipase, a cutinase, an amylase, a carbohydrase, a cellulase, a pectinase, a mannanase, an arabinase, a galactanase, a xylanase, an oxidase, e.g., a laccase, and/or a peroxidase, provided that the foam composition comprises at least one non cellulytic enzyme. Additional components of the foam composition comprise pH regulating agents and enzyme stabilizing agents.

In an even further aspect the invention relates to a device capable of performing the method according to the invention.

### DESCRIPTION OF THE DRAWINGS

FIG. 1. Schematic presentation of the model wash used in the Examples.

FIG. 2. Diagram showing the results of the comparative test in Example 1.

FIG. 3. Diagram showing the washing efficiency using foam treatment with enzymes in the foam and varying amounts of a commercial compact powder detergent in the water wash.

### DETAILED DESCRIPTION OF THE INVENTION

The invention is based on the observation that when an enzyme enriched foam are added to the fabric surprisingly increased wash benefits can be obtained compared to conventional wash

### The Foam Composition

The foam composition is an aqueous composition in form of a foam and comprises enzymes and at least one foaming agent, provided that if the foam composition comprises a cellulase then at least one further enzyme is included in the composition. Other components such as enzyme stabilizing agents, pH regulating components etc. may further be comprised in the compositions.

Enzymes to be used in the foam may in principle be any enzyme known to have an effect on stained fabrics, such as a protease, lipase, a cutinase, an amylase, a carbohydrase, a cellulase, a pectinase, a mannanase, an arabinase, a galactanase, a xylanase, an oxidase, e.g., a laccase, and/or a peroxidase.

In one preferred embodiment the foam composition consists of:
a) one or more foaming agents,
b) one or more enzymes
c) optionally one or more compounds selected among foam stabilizing agents, enzyme stabilizing agents, pH regulating agents, perfume and color;
d) water.

The enzymes to be used in the foam compositions according to the invention may be enzymes traditionally used in laundry, having optimal activity in the neutral to alkaline area, or enzymes having optimal activity in the acidic to neutral area.

Examples of enzymes for the foam composition include proteases, amylases, lipases, cellulases, cutinases, carbohydrases, cellulases, pectinases, mannanases arabinases, galactanases, xylanases oxidases e.g. laccases and peroxidises.

It is preferred that the foam composition comprises at least one protease since it surprisingly has been found that using the method according to the invention the performance of proteases may be considerable enhanced compared to a traditional laundering method.

Preferred enzymes for use in the foam compositions according to the invention are described in further details below:

Proteases: Suitable proteases include those of animal, vegetable or microbial origin. Microbial origin is preferred. Chemically or genetically modified mutants are included. The protease may be a serine protease, preferably an alkaline microbial protease or a trypsin-like protease. Examples of alkaline proteases are subtilisins, especially those derived from Bacillus, e.g., subtilisin Novo, subtilisin Carlsberg, subtilisin 309, subtilisin 147 and subtilisin 168 (described in WO 89/06279). Examples of trypsin-like proteases are trypsin (e.g. of porcine or bovine origin) and the Fusarium protease described in WO 89/06270.

Preferred commercially available protease enzymes include those sold under the trade names Alcalase, Savinase, Primase, Durazym, and Esperase by Novozymes A/S (Denmark), those sold under the tradename Maxatase, Maxacal, Maxapem, Properase, Purafect and Purafect OXP by Genencor International, and those sold under the tradename Opticlean and Optimase by Solvay Enzymes. Protease enzymes may be incorporated into the Foam compositions in accordance with the invention at a level of from 0.00001% to 10% of enzyme protein by weight of the composition, preferably at a level of from 0.0001% to 5% of enzyme protein by weight of the composition, more preferably at a level of from 0.001% to 2% of enzyme protein by weight of the composition, even more preferably at a level of from 0.01% to 1% of enzyme protein by weight of the composition.

Lipases: Suitable lipases include those of bacterial or fungal origin. Chemically or genetically modified mutants are included.

Examples of useful lipases include a Humicola lanuginosa lipase, e.g., as described in EP 258 068 and EP 305 216, a Rhizomucor miehei lipase, e.g., as described in EP 238 023, a Candida lipase, such as a C. antarctica lipase, e.g., the C. antarctica lipase A or B described in EP 214 761, a Pseudomonas lipase such as a P. alcaligenes and P. pseudoalcaligenes lipase, e.g., as described in EP 218 272, a P. cepacia lipase, e.g., as described in EP 331 376, a P. stutzeri lipase, e.g., as disclosed in GB 1,372,034, a P. fluorescens lipase, a Bacillus lipase, e.g., a B. subtilis lipase (Dartois et al., (1993), Biochemica et Biophysica acta 1131, 253-260), a B. stearothermophilus lipase (JP 64/744992) and a B. pumilus lipase (WO 91/16422).

Furthermore, a number of cloned lipases may be useful, including the Penicillium camembertii lipase described by Yamaguchi et al., (1991), Gene 103, 61-67), the Geotricum candidum lipase (Schimada, Y. et al., (1989), J. Biochem., 106, 383-388), and various Rhizopus lipases such as a R. delemar lipase (Hass, M. J et al., (1991), Gene 109, 117-113), a R. niveus lipase (Kugimiya et al., (1992), Biosci. Biotech. Biochem. 56, 716-719) and a R. oryzae lipase.

Other types of lipolytic enzymes such as cutinases may also be useful, e.g., a cutinase derived from Pseudomonas mendocina as described in WO 88/09367, or a cutinase derived from Fusarium solani pisi (e.g. described in WO 90/09446).

Especially suitable lipases are lipases such as M1 Lipase™, Luma Fast™ and Lipo-max™ (Genencor), Lipolase™ and Lipolase Ultra™ (Novo Nordisk A/S), and Lipase P “Amano” (Amano Pharmaceutical Co. Ltd.).

The lipases are normally incorporated in the foam composition at a level of from 0.00001% to 10% of enzyme protein by weight of the composition, preferably at a level of from 0.0001% to 5% of enzyme protein by weight of the composition, more preferably at a level of from 0.001% to 2% of enzyme protein by weight of the composition, even more preferably at a level of from 0.01% to 1% of enzyme protein by weight of the composition.

Amylases: Any amylase (α and/or β) may in principle be used. Suitable amylases include those of bacterial or fungal origin. Chemically or genetically modified mutants are included. Amylases include, for example, α-amylases obtained from a special strain of B. licheniformis, described in more detail in GB 1,296,839. Commercially available amylases are Duramyl™, Termamyl™, Fungamyl™ and BAN™ (available from Novozymes A/S) and Rapidase™ and Maxamyl P™ (available from Genencor).

The amylases are normally incorporated in the foam composition at a level of from 0.00001% to 10% of enzyme protein by weight of the composition, preferably at a level of from 0.0001% to 5% of enzyme protein by weight of the composition, more preferably at a level of from 0.001% to 2% of enzyme protein by weight of the composition, even more preferably at a level of from 0.01% to 1% of enzyme protein by weight of the composition.

Cellulases: Any cellulase may in principle be used. Suitable cellulases include those of bacterial or fungal origin. Chemically or genetically modified mutants are included. Suitable cellulases are disclosed in U.S. Pat. No. 4,435,307, which discloses fungal cellulases produced from Humicola insolens. Especially suitable cellulases are the cellulases having colour care benefits. Examples of such cellulases are cellulases described in European patent application No. 0 495 257.

Commercially available cellulases include Celluzyme™ produced by a strain of Humicola insolens, (Novozymes A/S), and KAC-500(B)™ (Kao Corporation).

Cellulases are normally incorporated in the foam composition at a level of from 0.00001% to 10% of enzyme protein by weight of the composition, preferably at a level of from 0.0001% to 5% of enzyme protein by weight of the composition, more preferably at a level of from 0.001% to 2% of enzyme protein by weight of the composition, even more preferably at a level of from 0.01% to 1% of enzyme protein by weight of the composition.

Peroxidases/Oxidases: Peroxidase enzymes are used in combination with hydrogen peroxide or a source thereof (e.g. a percarbonate, perborate or persulfate). Oxidase enzymes are used in combination with oxygen. Both types of enzymes are used for “solution bleaching”, i.e. to prevent transfer of a textile dye from a dyed fabric to another fabric when said fabrics are washed together in a wash liquor, preferably together with an enhancing agent as described in e.g. WO 94/12621 and WO 95/01426. Suitable peroxidases/oxidases include those of plant, bacterial or fungal origin. Chemically or genetically modified mutants are included.

Peroxidase and/or oxidase enzymes are normally incorporated in the foam composition at a level of from 0.00001% to 10% of enzyme protein by weight of the composition, preferably at a level of from 0.0001% to 5% of enzyme protein by weight of the composition, more preferably at a level of from 0.001% to 2% of enzyme protein by weight of the composition, even more preferably at a level of from 0.01% to 1% of enzyme protein by weight of the composition.

Mixtures of the above mentioned enzymes are encompassed herein, in particular a mixture of a protease, an amylase, a lipase and/or a cellulase.

The foaming agent may in principle be any such known foaming agent capable of forming a stable foam, such as high foaming surfactants selected among from anionic and/or cationic and/or ampholytic and/or zwitterionic and/or semi-polar surfactants. As examples of foaming agents can be mentioned ethoxylated alcohols, ethoxylated alkyl phenols, ethylene oxide and propylene oxide block polymers, carboxylic acid amides, sulphated amides, amine oxides or sulphated, phosphated, carboxylated or sulfonated alcohols and alkyl carboxylates, alkyl polyglucose solfosuccinates, alkyl polyglucose citrate and alkyl polyglucose tartrate, sarcosinates and nonionics.

It is preferred that the foaming agent does not comprise non-ionic surfactants since it has been found that at least some non-ionic surfactants have a slightly negative effect on the performance of enzymes included in foams comprising such non-ionic surfactants and therefore may the unexpected beneficial effect using the method according to the invention be smaller using such non-ionic surfactants compared to the situation where a different surfactant, e.g. an anionic surfactant, is used.

It is more preferred that the foaming agent is selected among anionic surfactants.

Preferred examples of foaming agents include Eucerin and sodium linear C₁₂ alkyl benzene sulphonate (LAS).

The foam composition may further comprise one or more foam stabilizers such as glucosides or emulsifiers known to be able of stabilizing water/surfactant/gas emulsions.

The enzyme(s) of the foam composition of the invention may be stabilized using conventional enzyme stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid.

The foam compositions may also contain pH regulating compounds known by the skilled person. As examples of pH regulating compounds can be mentioned inorganic salts such as phosphates, sulphates and carbonates, organic compounds such as carboxylic acids, carboxylates, amines, sulphonates etc.

The pH regulating compounds should be selected so the pH value of the foam composition provides optimal conditions for the enzymes included in the composition.

Traditionally detergent compositions in general have pH values in the alkaline or neutral area in part because of the alkaline nature of many soaps, surfactants and other components commonly used in traditional detergent compositions. In contrary the foam compositions according to the invention contain no mandatory soap or surfactant components and are therefore not restricted to maintain a pH value in a particular range but the pH value of the compositions can be selected in order to obtain optimal conditions for the enzymes comprised in the composition. Thus, the pH of the foam composition can be in the acidic range, in the alkaline range or it can be neutral. In particular the pH can be selected in the range of 4-10, more preferred in the range of 5-9.

pH regulating compounds according to the invention includes well known buffer components such as glycine and sodium carbonate.

The skilled person will understand that the method according to the invention provides an additional versatility regarding the enzymes used in the laundering process. Thus, in one embodiment the foam composition has an acidic pH value and the enzymes are selected in order to have maximal activity under acidic conditions, in another embodiment has the foam composition a neutral pH value and the enzymes are selected in order to have maximal activity under neutral conditions and in a third embodiment has the foam composition an alkaline pH value and the enzymes are selected in order to have maximal activity under alkaline conditions. In contrast traditional detergent compositions have alkaline pH values and only enzymes having activity under alkaline conditions are suitable for such traditional detergent compositions.

A preferred foam composition according to the invention comprises following ingredients:

| | |
|---|---|
| Foaming agent | 0.1-40% |
| Enzymes (calculated as w/w protein) | 0.001-20% |
| pH regulating components, | 0-5% |
| foam and/or stabilizers, etc. | |
| Water | ad 100% |

The foam compositions according to the invention may in principle be made using known foaming methods. Methods for preparing foam are well known within the area of cleaning hard surfaces in e.g. the food industry, and it should be understood that such well known methods and equipment used for such methods also may be applied to the present invention.

One method for preparing the foam composition according to the invention is mixing and foaming the ingredients in a high shear mixer.

Another method for preparing the foam composition according to the invention is providing the ingredients under pressure in a container together with a suitable propellant and creating the foam composition by dispensing the composition through a suitable orifice using technologies as will be well know from spray cans or aerosol cans.

The propellant may be any compound that is a compressible gas at ambient temperature and is inert toward the foam compositions; however it is preferred to use a propellant that additionally is harmless for the users and the environment. Such propellants as will be well known within the area can also be used within the present invention. As examples of suitable propellants can be mentioned nitrogen, propane and butane.

Another method for making foam is to use the conventional method for foam dispertion in fx. hard surface cleaning, by having a concentrated detergent in a container. In the foaming situation a water flow draws out a proportional amount of detergent (to the water) to the foaming nozzle. The concentration of detergent is dependent on the water pressure. The enzyme may be included in the detergent composition or it can be placed in a separate container and being dragged out in the water detergent flow to the foaming nozzle.

It is also possible to prepare the foam composition manually, by mixing the ingredients and foaming of the mixture using by mechanical action, e.g. by whipping the foam or by using a hand foamer. Hand foamers are known in the art and will also be useable according to the present invention.

### The Detergent Composition

The detergent composition is according the invention added together with water in step b. of the method.

The detergent composition may in principle be any known detergent composition, however it is preferred that the detergent is particular adapted to use in the method according to the invention.

The detergent composition may comprise enzymes or it may not comprise enzymes. If the detergent composition does not comprise enzymes the only enzymes active during step b. of the inventive method are enzymes included in the foam composition. It is preferred that the detergent composition comprises enzymes.

Thus, in one embodiment the detergent composition comprises a surfactant system and a builder system and preferably one or more of the following components: enzymes, bleaching agents, suds suppressors, pH regulating components, soil-suspending agents, soil-releasing agents, optical brighteners, abrasives, bactericides, tarnish inhibitors, coloring agents, softening agents, polymeric dye transfer inhibiting agents and/or encapsulated or non encapsulated perfumes.

The detergent composition may for example be formulated as a hand or machine laundry detergent composition.

The detergent composition comprises one or more surfactants, which may be non-ionic including semi-polar and/or anionic and/or cationic and/or zwitterionic. The surfactants are typically present at a level of from 0.1% to 60% by weight.

When included therein the detergent will usually contain from about 1% to about 40% of an anionic surfactant such as linear alkylbenzenesulfonate, alpha-olefinsulfonate, alkyl sulfate (fatty alcohol sulfate), alcohol ethoxysulfate, secondary alkanesulfonate, alpha-sulfo fatty acid methyl ester, alkyl- or alkenylsuccinic acid or soap.

When included therein the detergent will usually contain from about 0.2% to about 40% of a non-ionic surfactant such as alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, or N-acyl N-alkyl derivatives of glucosamine (“glucamides”).

The detergent may contain 0-65% of a detergent builder or complexing agent such as zeolite, diphosphate, triphosphate, phosphonate, carbonate, citrate, nitrilotriacetic acid, ethylenediaminetetraacetic acid, diethylenetriaminepentaacetic acid, alkyl- or alkenylsuccinic acid, soluble silicates or layered silicates (e.g. SKS-6 from Hoechst).

The detergent may comprise one or more polymers. Examples are carboxymethylcellulose, poly(vinylpyrrolidone), poly (ethylene glycol), poly(vinyl alcohol), poly(vinylpyridine-N-oxide), poly(vinylimidazole), polycarboxylates such as polyacrylates, maleic/acrylic acid copolymers and lauryl methacrylate/acrylic acid copolymers.

The detergent may contain a bleaching system which may comprise a H₂O₂ source such as perborate or percarbonate which may be combined with a peracid-forming bleach activator such as tetraacetylethylenediamine or nonanoyloxybenzenesulfonate. Alternatively, the bleaching system may comprise peroxyacids of e.g. the amide, imide, or sulfone type.

The enzyme(s) of the detergent composition of the invention may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, and the composition may be formulated as described in e.g. WO 92/19709 and WO 92/19708.

The detergent may also contain other conventional detergent ingredients such as e.g. fabric conditioners including clays, foam boosters, suds suppressors, anti-corrosion agents, soil-suspending agents, anti-soil redeposition agents, dyes, bactericides, optical brighteners, hydrotropes, tarnish inhibitors, or perfumes.

### Enzymes

Preferred detergent compositions comprise enzyme(s) which provides cleaning performance and/or fabric care benefits. In the method of the present invention a foam composition comprising enzymes are used in step a) of the method according to the invention. If step a) is performed before step b) the enzymes present in the foam composition will also be present during step b) and in this embodiment it may be desirable not to include enzymes in the detergent composition, or it may be desirable to include a different set of enzymes in the detergent composition compared to the set of enzymes included in the used foam composition.

Such enzymes include other proteases, lipases, cutinases, amylases, cellulases, peroxidases, oxidases (e.g. laccases).

A detailed description of the enzymes can be found under the description of the foam composition, however, it should be kept in mind that enzymes to be included in the detergent composition of the invention should have high activity in the alkaline to neutral pH determined by the detergent composition.

The enzymes incorporated in the detergent composition, are normally incorporated in the detergent composition at a level from 0.00001% to 2% of enzyme protein by weight of the composition for each enzyme, preferably at a level from 0.0001% to 1% of enzyme protein by weight of the composition, more preferably at a level from 0.001% to 0.5% of enzyme protein by weight of the composition, even more preferably at a level from 0.01% to 0.2% of enzyme protein by weight of the composition. The enzymes incorporated in the detergent composition, are normally incorporated in the detergent composition at a level from 0.00001% to 5% of enzyme protein by weight of the composition for each enzyme, preferably at a level from 0.0001% to 2% of enzyme protein by weight of the composition, more preferably at a level from 0.001% to 1% of enzyme protein by weight of the composition, even more preferably at a level from 0.01% to 1% of enzyme protein by weight of the composition.

The enzymes included in the detergent composition may be of the same type as the enzymes included in the foam composition or they may be of a different type.

### Method of the Invention

The laundering according to the invention comprises two steps
a. A foam composition comprising one or more enzymes is distributed over the textile fabrics followed by a holding period, and
b. Water and optionally a detergent composition is added to the fabrics and the mixture is agitated for a second period.
   Following step a) and step b) the laundering process is usually completed by rinsing the fabrics in water and drying, using well known procedures for these purposes. If desired a treatment using a fabric softener may also be included.

### Step a)

In this step foam composition is distributed over the fabrics. It is important that the foam composition is evenly distributed over the fabrics in order to secure a uniform laundry. The distributing of the foam composition over the fabrics may be performed by hand or it may be performed automatically in a washing machine.

One way to distribute the foam is by providing the fabrics in a container, adding the foam composition and slowly agitating the mixture for a short period such as a few minutes until the foam composition is evenly distributed.

One method for distributing the foam composition over the fabrics is providing the fabrics in the drum of a washing machine, adding the foam composition and rolling the drum slowly for a few minutes and thereby distributing the foam composition.

Another method for distributing the foam composition over the fabrics is distributing the foam by hand.

In a preferred embodiment the fabrics are prewetted before the foam composition is distributed. At least for some foam compositions and/or some types of fabrics prewetting of the fabrics facilitates an evenly distribution of the foam composition over the fabrics.

The term “prewetted” is in the present specification and claims intended to mean that the fabrics are essentially saturated with water. The exact amount or residual water in the fabrics is not essential for the invention, but it is preferred that the prewetted fabrics are so dry so that practically no dripping of water of the fabrics takes place. Further, the suitable amount of water in the prewetted fabric depends on the particular fabric being treated since different fabrics have different capacities for binding and retaining water, for example is it well known that some natural fibres, such as cotton, can bind relatively large amounts of water whereas some synthetic fibres, such as polyester, binds relatively small amounts of water. The suitable ratio of water to fabrics can for particular fabrics be determined using simple experiments. Generally, a ratio of water to fabrics of 0.2-0.8 g water per 1 g fabric, preferably 0.4-0.6 g water per 1 g fabric, will be suitable for most fabrics, and such a ratio can generally be applied with a satisfactory result without the need for further experimentation.

The fabrics can be prewetted by soaking into water where after superfluous water is removed from the fabrics e.g. manually by wringing the fabrics or squeezing water out of the fabrics, or by a brief centrifugation. The skilled person will appreciate that other methods for prewetting fabrics may be used according to the invention.

In the holding period after distributing the foam composition the fabrics rest and the enzymes acts on the stains. The holding period should be sufficiently long to secure that the enzymes have hydrolysed their substrates to an extent where the stains readily can be dissolved. A holding period of between 1 minute and 2 hours is generally sufficient, preferably between 2 minutes and 30 minutes, more preferred between 5 minutes and 20 minutes and most preferred about 10 minutes.

The temperature during step a) is not critical as long as the enzymes remain active during said temperature. The skilled person will appreciate that some enzymes will be suitable for a low temperature, whereas others may be suitable for higher temperatures. Thus, taking due care to the selection of enzymes and the particular fabrics being laundered a suitable temperature for step a) can be selected. Generally the temperature is in the range of 0-90° C., however it is preferred using a temperature between ambient temperature and approximately 40° C., more preferred between ambient temperature and 30° C.

### Step b)

In step b) water and optionally a detergent composition is added to the fabrics and the fabrics are washed under agitation at a certain temperature and time, essentially as washing takes place during an ordinary laundry process.

It is preferred to add a detergent composition in step b),

In this step suds are created and the fabrics are cleaned by agitation in a certain time. The step is conveniently performed in a washing machine having a drum, where the agitation is created by rotating the drum as it will be known from conventional laundering processes. Step b) may in principle be performed over any time period deemed convenient for removing stains from the fabrics; however, generally it is preferred to avoid a too long step b) in order to complete laundering process within a reasonable time. Usually step b) is performed for a time period in the range of 10 minutes to 2 hours, preferably in the range of 10 minutes to 1 hour and most preferred between 15 and 30 minutes.

In step b) all components of the foam composition will be contained in the mixture of fabrics, detergent and water. This has the consequence that the enzymes present in the foam composition and may continue exerting their activities during step b).

In one embodiment the detergent composition does not contain any enzyme. In this embodiment the laundry process according to the invention is performed with the enzymes of the foam composition being present and possible acting during the complete laundering process.

In another embodiment the detergent composition contains enzymes as described above. In this embodiment the enzymes of the foam composition will be present and possible acting during the complete laundry process and the enzymes of the detergent composition will be present and acting during step b).

The enzymes included in the detergent composition may be the same enzyme types having essentially same specificities as the enzymes included in the foam composition.

Alternatively, the enzymes included in the detergent composition may be different from the enzymes included in the foam composition, being of different enzyme types and/or having different specificities than the enzymes included in the foam composition. In this embodiment step a) will be performed under presence of one set of enzymes having one set of specificities and step b) will be performed under presence of a different set of enzymes optionally having a different set of specificities.

The physically/chemically conditions in step a) may be selected similarly or differently compared to the conditions in step b).

Thus step a) may for example be performed under acidic to neutral conditions and step b) may be performed under alkaline conditions. This embodiment offers the possibility of including one set of enzymes in the foam composition said enzymes having optimal activity under the acidic to neutral conditions under step a) and a different set of enzymes may be included in the detergent composition, said enzymes having optimal activity under the alkaline conditions under step b).

In case that it is desired to include a lipase in the laundry process it is according to the invention preferred to include the lipase in the foam composition, since the relative low water activity in step a) is favourable for lipases, which are known to perform better under low water conditions.

Finally, since enzymes by nature are proteinaceous they will to some extent be sensitive to the action of proteases. The present invention provides the opportunity of including particular protease sensitive enzymes in the foam composition in order to have maximum activity during step a), and include protease in the detergent composition according to the invention and have the protease activity during step b).

Additionally, in case that a detergent composition comprising bleach is used it will be possible to include bleach sensitive enzymes in the foam composition and bleach tolerant enzymes in the detergent composition and thereby a more effective cleaning is obtained than if all enzymes were included in the detergent composition.

Thus the present invention offers a tremendous versatility in the laundering process depending of the particular selected foam composition and detergent composition and the particular selection of enzymes included in these compositions.

The laundering process according to the invention has the advantage that it can be performed using small amounts of water for the laundering process compared with traditional laundering processes where all components are added as one composition. Further the amount of water and energy consumed in the process is low compared with traditional laundering processes.

Furthermore, an acceptable laundering result can be achieved using a smaller amount of detergent composition compared to the traditional laundering process where all enzymes water and detergent composition are added from the start.

The laundering process according to the invention provides an enhanced cleaning efficiency compared with traditional laundering processes where all components are added as one composition. Without wishing to be bound by any theory it is believed that the high efficiency according to the invention is a consequence of the low amount of water and following high concentration of enzyme and surfactant on the surface of the textile during step a. which provides for a very efficient enzymatic degradation of stains.

This have the consequence that the laundering according to the invention may be performed on a shorter time achieving same result as would have taken longer time using a conventional laundering process.

In a further aspect the invention relates to a device for performing the laundering process according to the invention comprising a container for the fabrics, a foam composition delivering device, means for agitating the laundering mixture, water connections and device for detergent composition.

The container for the fabrics holds the fabrics during the laundering process. A convenient container for the fabrics is a perforated metal drum as will be known from traditional washing machines. The drum may be mounted horizontally or vertically depending on the overall design of the device.

Means for agitation the laundering mixture are well known within the area of washing machines. Conveniently the agitation is provided by rotating the drum around its longitudinal axis. Means for rotating a drum around its longitudinal axis well known within the area of traditional washing machines will also apply for the present invention.

The foam composition delivering device may in principle be any device capable of preparing and delivering the foam composition according to the invention. In one embodiment the foam composition delivering device consists of a whipping device capable of preparing the foam composition from a composition comprising all the ingredients of the foam composition but in a non foam form. In another embodiment the foam composition delivering device is a holder capable of accepting a pressurized can capable of delivering the foam composition by actuating an actuator. In other embodiments the foam composition delivering device comprises a nozzle where the surfactant and enzyme is injected into a jet of water, whereby foam is created.

Devices for preparing and delivering foam are well known within the art, e.g. for delivering a form for cleaning hard surfaces, and such devices may also be used within the present invention.

Water connections comprise a water supply and a water outlet. Further heating devices and thermostats for adjusting the temperature of the water may be provided. The water flow is controlled by suitable valves and pumps as it will be appreciated by the skilled person.

Devices for detergent composition well known within the area of traditional washing machines will also apply for the present invention. The device for detergent composition may be a detergent tray as it will be found on many conventional washing machines.

Preferably the device for performing the laundering process according to the invention is automated being capable of controlling the complete laundering process in a predetermined program. One preferred program for the laundering process according to the invention comprises following steps:
fabrics are loaded in the container for the fabrics;
water is added and the fabrics are prewetted and surplus of water is removed;
foam composition is supplied and distributed over the fabrics by gentle agitation;
holding period where the fabrics rests for a predetermined time;
water and detergent are supplied and the fabrics are washed by agitating for a predetermined period;
suds are drained;
water is added and the fabrics are rinsed; and
after draining of the rinsing water the fabrics are removed and dried.

The skilled person will appreciate that a number of centrifugation steps may be included in order to secure a more efficient removal of water or suds.

The invention is now illustrated in further details by way of the following examples, which are provided solely for illustratory purposes and should not be considered limiting in any way.

### EXAMPLES

### Materials and Methods

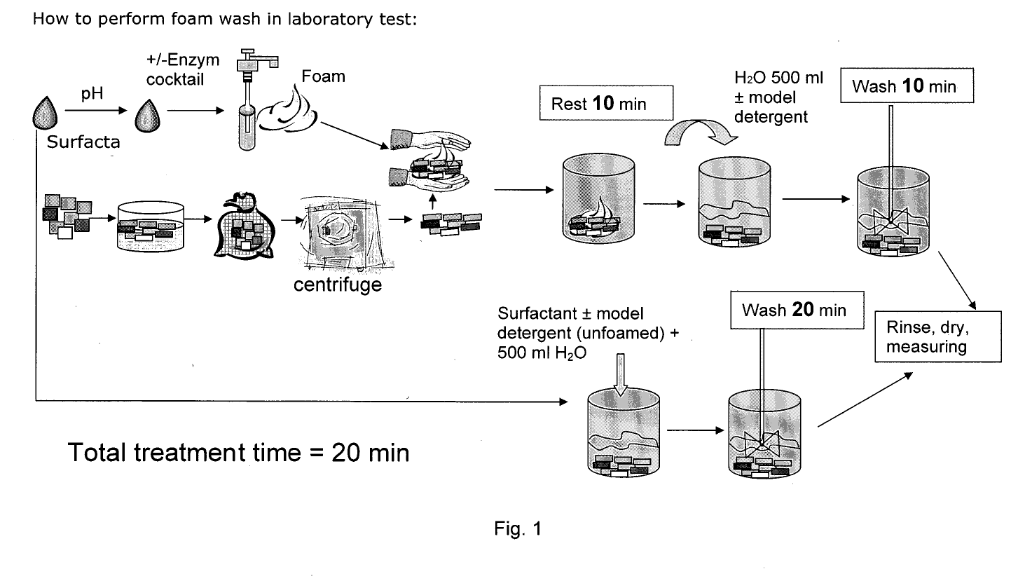

Wash method: Swatches are cut, marked and placed in washing string bag and wetted in a washing machine and centrifuged at 400 rpm in 4 min. Those swatches that shall be foamed are placed in glass beakers. Swatches that are being washed for 20 min are placed directly in the TOM beakers with 500 ml wash solution of 1 g Eucerin±enzyme cocktail.
1 ml of hand wash lotion Eucerin with or without enzyme is added to 7 ml of tap water 21° dH mixed and foam up with a finger foamer. This foam is added to the swatches in the glass beakers and mixed briefly with a rubber spatula. Rest for 10 min and are flushed out of the glass beaker with the 482 ml wash solution down to the TOM-beakers and wash 10 minutes with same conditions as the 20 minutes wash.
After wash the swatches from each beaker are rinsed in flowing cold tap water and placed in a washing string bag and centrifuged for 4 min at 400 rpm.
Dried at room temperature over night and remission is measured in color eye at 460 nm.
The wash method is shown schematically in FIG. 1.

### Conditions:

| | |
|---|---|
| Volume: | 500 ml tap water |
| Enzyme | Lipex 2000 LU/l |
| Dosages: | Celluclean 50 ECU/l |
| Cocktail 1 | Stainzyme 0.5 mg ep/l |
| | Savinase 40 nM |
| | Mannaway 0.25 mg ep/l |
| | All enzymes were obtained from Novozymes A/S, Bagsværd Denmark |
| Soil: | 2 of each soil types (circles 2.5 cm and squares 3.5 × 3.5 cm |
| | Approx. 5 g. |
| Tracer: | WFK10A cotton (5 × 5 cm) |
| | wfk30A(5 × 5 cm) |
| Temp.: | room temp. app. 22° C. |
| Time | Total treatment time is 20 min for all experiments shown in this report. One |
| | example of foam wash is: 10 min of foam + enzyme cocktail added to wetted |
| | swatches followed by 10 min of water wash. |
| RPM: | 120 |
| Rinse: | 5 minutes in cold tap water and centrifuged in a washing machine (front |
| | loader) 400 rpm in 3 min |
| Detergent: | Eucerin: Aqua • Sodium Coco amphoacetate • Sodium Myreth Sulfate • |
| | Lauryl Glucoside • Citric Acid • PEG-40 Hydrogenated Castor Oil • Coco |
| | Glucoside • Sodium Benzoate • Glycol Distearate • Glycerin • Sodium |
| | Salicylate • Polyquaternium-10 • PEG-200 Hydrogenated Glyceryl Palmate • |
| | Diammonium Citrate • Parfume |
| | Eucerin was purchased from Beiersdorf A/S, Copenhagen, Denmark. |

Swatches used in examples 1 and 2

| Marking | Name | number |
|---|---|---|
| 1, small | EMPA101, olive oil/carbon black | 2 |
| 2, large | EMPA111, blood | 2 |
| 3, large | EMPA106, motor oil | 2 |
| 4, large | EMPA112, cocoa on cotton | 2 |
| 5, large | EMPA114, red wine | 2 |
| 6, small | EMPA117, blood/milk/ink | 2 |
| 7, large | EMPA164, grass | 2 |
| 8, large | Wfk 10TE, clay | 2 |
| 9, small | Wfk 10D, sebum/carbon black | 2 |
| 10, large | wfk 10U, curry | 2 |
| 11, large | Wfk 10WB, blueberry juice | 2 |
| 12, small | Wfk 20D | 2 |
| 13, small | Wfk 20MU | 2 |
| 14, large | Wfk 10062 potato starch/pigment | 2 |
| 15, small | CS-28, rice starch | 2 |
| 16, small | EMPA120 | 2 |
| 17, small | wfk 10A, 100% cotton, no soil, pre- | 2 |
| | washed | |
| 18, small | wfk 30A, 100% polyester, no soil, pre- | 2 |
| | washed | |

Small 2.5 × 2.5 cm
Large 3.5 × 3.5 cm (cut in slant)
EMPA 111, EMPA 117 and EMPA 164 are considered protease sensitive stains.
EMPA 101, EMPA 106 and wfk 10TE are considered surfactant sensitive stains.
EMPA 112, wfk 10D, wfk 20D, wfk 20MU and EMPA 120 are considered lipase sensitive stains.
EMPA 114, wfk 10U and wfk 10WB are considered bleach sensitive stains.
Wfk 10062 and CS-28 are considered amylase sensitive stains.
Wfk 10A and wfk 30A are trace swatches.

The swatches were obtained from Center for Testmaterials BV, Vlaardingen, the Netherlands.

### Example 1

In this example the performance of the method is illustrated in the model wash method, using Eucerin as the surfactant and detergent, tapwater having a hardness of 21° dH, a temperature of 22° C. and a total treating time of 20 minutes. After the treatment the wash solution was removed by centrifugation at 120 rpm
Following 4 washes was performed, each was containing 2 of each swatches. The result was calculated as the sum of the remissions for all treated swatches.

| Beaker | Wash solution | Treatment |
|---|---|---|
| #1 | 1 g Eucerin, Tapwater | 1 g Euc/8 ml H₂O foam 10 min + |
| | | 482 ml H₂O; 10 min wash |
| #2 | 1 g Eucerin + Enzyme | 1 g Euc + enzymes/8 ml H₂O foam 10 |
| | cocktail, Tapwater | min + 482 ml H₂O; 10 min wash |
| #3 | 1 g Eucerin, Tapwater | 1 g Euc in 500 ml H₂O; 20 min wash |
| #4 | 1 g Eucerin + Enzyme | 1 g Euc + enzymes in 500 ml H₂O; |
| | cocktail, Tapwater | 20 min wash |

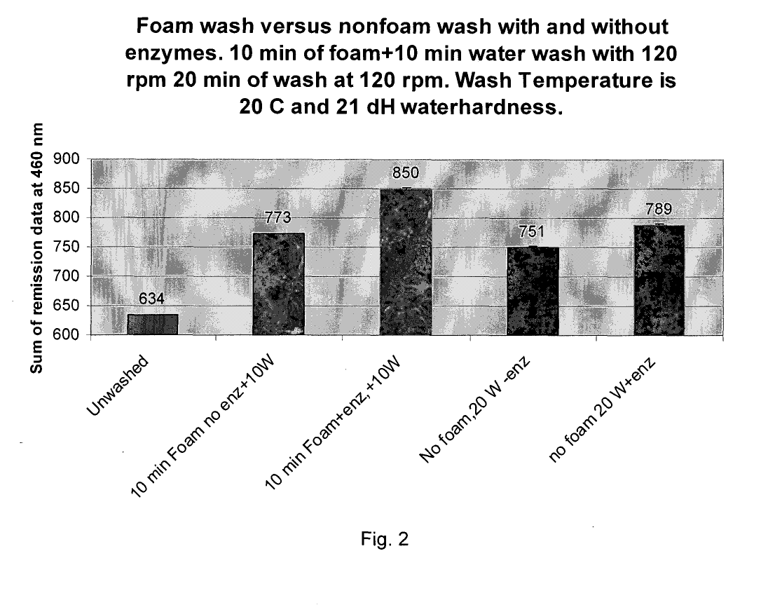

The results are shown in FIG. 2. The experiment shows that the washes using the enzyme cocktails perform significantly better than without enzymes (compare #2 and #4 with #1 and #3, respectively). Further the wash #2 according to the invention using a foam step with enzymes in the foam performs significantly better than the wash #4 using same enzyme cocktail and surfactant/detergent but without a foam step.

### Example 2

Foam test with Sodium linear C₁₂ alkyl benzene sulphonate (LAS) and enzyme cocktail with an EU compact powder detergent with bleach and enzymes (HDP detergent) in the water wash step. The LAS is adjusted to pH 9 in the foam and there is not added any buffering agents.
A foam wash in this test is a wash where half the wash is a LAS foam plus enzyme cocktail incubation step followed by a water wash step with different amounts of HDP in the wash solution. The test is done in a Terg-O-Tometer (TOM).
We compare this foam wash with a traditional TOM wash where the whole wash is a water wash cycle and with the corresponding ingredients to the foam washes. Total treatment time for both ways of washing is 20 min. The wash conditions in this test is Room temperature (22° C. and tap water 21° dH), the same stain set is used here as in the Example 1. Water wash is done in 500 ml H₂O, with various amounts of detergent added. The HDP detergent is EU compact powder detergent with bleach and enzymes.
After the treatment the results were measured using same method as in Example 1.

### Wash Setup:

| | Wash No: | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Foam | 0.25 g/ | 0.25 g/ | 0.25 g/ | 0.25 g/ | 0.25 g/ | 0.25 g/ | 0.25 g/ | 0.25 g/ | 0.25 g/ | 0.25 g/ | — | — |
| amount | 10 ml | 10 ml | 10 ml | 10 ml | 10 ml | 10 ml | 10 ml | 10 ml | 10 ml | 10 ml | | |
| Foam | 10 min | 10 min | 10 min | 10 min | 10 min | — | — | — | — | — | — | — |
| treatment | | | | | | | | | | | | |
| Enzyme | 1x | 1x | 1x | 1x | 1x | 1x | 1x | 1x | 1x | 1x | | 1x to |
| in foam | | | | | | | | | | | | wash |
| | | | | | | | | | | | | solution |
| Wash: | 0 g/l | 0.05 g/l | 0.5 g/l | 2.5 g/l | 5 g/l | 0 g/l | 0.05 g/l | 0.5 g/l | 2.5 g/l | 5 g/l | 5 g/l | 5 g/l |
| HDP | | | | | | | | | | | | |
| conc | | | | | | | | | | | | |
| Wash | 10 min | 10 min | 10 min | 10 min | 10 min | 20 min | 20 min | 20 min | 20 min | 20 min | 20 min | 20 min |
| Time | | | | | | | | | | | | |

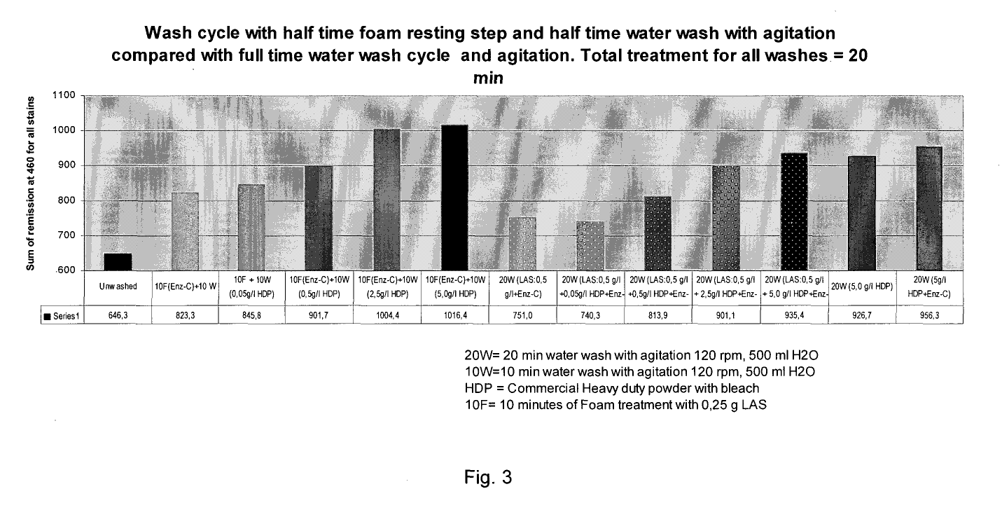

In wash no 6-11 the foam composition was applied to the swatches immediately before addition of water and HDP, with the result that no foam treatment period existed in these tests. In wash no 11 and 12 no foam was added but the corresponding amount of LAS, and enzyme cocktail in 12 was added in the water wash.
The results are shown in FIG. 3.
Again a considerable enhancement of the method according to the invention using enzyme cocktail in the foam composition can be observed. The results further indicate that satisfactory laundering results can be obtained with lower amounts of detergent composition using the method according to the invention.

### Example 3

In this example the effect of increasing the enzyme dosage in foam wash and in TOM wash is examined. A foam composition comprising LAS was used in the example. As detergent the commercial available product Ariel Sensitive® was used. In the TOM wash same amount of LAS as contained in the foam composition was added.
The foam wash was conducted by distributing a foam prepared by foaming a mixture of 30 ml water, 0.25 g LAS (8.3 g/l LAS) and enzymes as indicated, on the swatches (7.5 g) and incubating in 5 minutes. Next 450 ml tap water (15 dH°) and detergent composition (0.5 g/l Ariel Sensitive®) was added and the swatches were washed in a TOM for 15 minutes at 20° C. Suds were discarded and the remittance of the swatches measured.
A total of four foam washes were done using no enzymes, 1× enzyme mixture, 3× enzyme mixture and 5× enzyme mixture.
The TOM wash was conducted by adding swatches (7.5 g), 450 ml water, detergent (Ariel Sensitive® in a concentration of 0.5 g/l), LAS and enzymes as indicated. LAS and enzymes was added as a 30 ml solution 8.3 g/l LAS in order to have same amount of each component as in the foam wash. The swatches were washed in 20 minutes at 20° C. Suds were discarded and the remittance of the swatches measured.
The obtained results were calculated as delta remittance, which is the remittance of the unwashed swatches subtracted the remittance of the washed swatches. Total delta remittance is the sum of the delta remittances for all swatches.
The composition of the enzyme mixture (1×) used in this example is following:
Lipex: 0,150 mg ep
Savinase: 0,480 mg ep
Amylase: 0,225 mg ep
Celluclean: 0,150 mg ep
   Where ep stand for enzyme protein
   Following swatches were used in this example:

| Marking | Name | number |
|---|---|---|
| 1 | EMPA101, olive oil/carbon black | 2 |
| 2 | EMPA106, motor oil | 2 |
| 3 | EMPA112, milk/cacao | 2 |
| 4 | EMPA114, red wine | 2 |
| 5 | EMPA116, blood/milk | 2 |
| 6 | EMPA117, blood/milk/ink | 2 |
| 7 | EMPA118 | 2 |
| 8 | EMPA164, grass | 2 |
| 9 | Wfk 10U, curry | 2 |
| 10 | Wfk 10D, sebum/carbon black | 2 |
| 11 | Wfk 10TE, clay | 2 |
| 12 | CS-20 | 2 |
| 13 | Wfk 20MU | 2 |
| 14 | CS-27, potato starch | 2 |
| 15 | CS-28, rice starch | 2 |
| 16 | WFK 10 WB | 2 |
| 17 | EMPA120 | 2 |
| 18 | wfk 10A, 100% cotton, no soil, pre- | 2 |
| | washed | |
| 19 | wfk 30A, 100% polyester, no soil, pre- | 2 |
| | washed | |

Following results were obtained:

| | Foam wash | TOM wash |
|---|---|---|
| | Total delta remittance | Total delta remittance |
| No enzyme | 187 | 133 |
| 1 X enzyme mixture | 241 | 180 |
| 3 X enzyme mixture | 258 | 191 |
| 5 X enzyme mixture | 256 | 198 |

The results show that the foam wash method according to the invention provides a superior wash result for all enzyme dosages.

### Example 4

The TOM wash of example 3 was repeated without addition of the enzyme mixture but with a 10 fold higher dosage of the detergent composition (5.0 g/l Ariel Sensitive®), which is the dosage recommended by the manufacturer. A total delta remittance of 268 was found.
This example shows that using the method of the invention similar satisfactory laundering results can be obtained using a low detergent dosage as would require a considerable higher detergent dosage using a traditional, TOM wash.

### Example 5

In this example the effect of the method of the invention was tested without further detergents added. Thus, the experiments described in example 3 were repeated without addition of detergent composition.
Following results were obtained:

| | Foam wash | TOM wash |
|---|---|---|
| | Total delta remittance | Total delta remittance |
| No enzyme | 150 | 112 |
| 1 X enzyme mixture | 220 | 159 |
| 3 X enzyme mixture | 232 | 166 |
| 5 X enzyme mixture | 237 | 162 |

These results demonstrate the superior results obtained using the method of the invention compared to a traditional laundering method.

### Example 6

In the experiment performed in Example 5 the results from the protease sensitive swatches were calculated. Swatches considered protease sensitive are: EMPA 116, EMPA 117 and EMPA 164.

| | Foam wash | TOM wash |
|---|---|---|
| | Total delta remittance | Total delta remittance |
| | on protease | on protease |
| | sensitive swatches | sensitive swatches |
| No enzyme | 25 | 3 |
| 1 X enzyme mixture | 47 | 9 |
| 3 X enzyme mixture | 54 | 10 |
| 5 X enzyme mixture | 57 | 8 |

This demonstrates the unexpected superior effect of the method of the invention compared to a traditional TOM method.

1-13. (canceled)

14. A method of laundering of fabrics, comprising the steps of:
a) distributing a foam composition over fabrics, where the foam composition comprises one or more enzymes, followed by a holding period; and
b) adding water and optionally a detergent composition to the fabrics and agitating the fabrics for a second period.

15. The method of claim 14, where the fabrics are prewetted before the foam composition is distributed.

16. The method of claim 14, wherein the one or more enzymes of step a) are selected from the group consisting of: proteases, lipases, cutinases, amylases, carbohydrases, cellulases, pectinases, mannanases, arabinases, galactanases, xylanases, oxidases and peroxidases.

17. The method of claim 14, wherein the holding period in step a) is in the range of 1 minute to 2 hours.

18. The method of claim 14, wherein the holding period in step a) is in the range of from 2 minutes to 30 minutes.

19. The method of claim 14, wherein the holding period in step a) is in the range of from 5 minutes to 20 minutes.

20. The method of claim 14, wherein the holding period is about 10 minutes.

21. The method of claim 14, wherein a detergent composition is added in step b).

22. The method of claim 14, wherein the agitation in step b) is performed over a period in the range of 10 minutes to 2 hours.

23. The method of claim 14, wherein the agitation in step b) is performed over a period in the range of 10 minutes to 1 hour.

24. The method of claim 14, wherein the agitation in step b) is performed over a period in the range of 10 to 30 minutes.

25. A foam composition comprising a foaming agent and one or more enzymes selected from the group consisting of proteases, lipases, cutinases, amylases, carbohydrases, cellulases, pectinases, mannanases, arabinases, galactanases, xylanases, oxidases and peroxidases, and
provided that if a cellulase is present in the composition at least one further enzyme is also included.

26. The foam composition of claim 25, comprising:
a) one or more foaming agents;
b) one or more enzymes;
c) one or more further compounds selected from the group consisting of pH regulating agents, foam stabilizing agents, enzyme stabilizing agents; and
d) water.

27. The foam composition of claim 25, wherein the one or more foaming agents does not comprise non-ionic surfactants.

28. The foam composition of claim 25, wherein the one or more foaming agents comprises an anionic surfactant.

29. The foam composition of claim 25, wherein the one or more foaming agent is selected from the group consisting of ethoxylated alcohols, ethoxylated alkyl phenols, ethylene oxide and propylene block polymers, carboxylic acid amides, sulphated amides and amine oxides.

30. The foam composition of claim 25, wherein the enzymes each comprise 0.00001% to 10% w/w, preferably 0.0001 to 5% w/w, preferably 0.001 to 2% w/w most preferred 0.01 to 1% w/w based on the total weight of the foam composition.

31. The foam composition of claim 25, wherein the enzymes each comprise 0.0001 to 5% w/w based on the total weight of the foam composition.

32. The foam composition of claim 25, wherein the enzymes each comprise 0.001 to 2% w/w based on the total weight of the foam composition.

33. The foam composition of claim 25, wherein the enzymes each comprise 0.01 to 1% w/w based on the total weight of the foam composition.
